(19) United States
(12) Patent Application Publication
(10) Pub. No.: US 2013/0014845 A1
(43) Pub. Date: Jan. 17, 2013

(54) SPOOL TYPE HYDRAULIC CONTROL VALVE WHICH SPOOL IS SEALED WITH ALL METAL SEAL RING

(71) Applicant: Kyong Tae Chang, Academy Town (KR)

(72) Inventor: Kyong Tae Chang, Academy Town (KR)

(73) Assignee: NEO MECHANICS LIMITED, Hong Kong (HK)

(21) Appl. No.: 13/548,219

(22) Filed: Jul. 13, 2012

Related U.S. Application Data
(60) Provisional application No. 61/508,046, filed on Jul. 14, 2011.

(51) Int. Cl. F16K 11/07

(52) U.S. Cl. 137/625.69; 251/900

(57) ABSTRACT

A spool type control valve, comprising: a valve block having a cylinder bore with drilled holes on the cylinder bore internal wall; a valve spool inserted in the cylinder bore; wherein the valve spool having separation sleeves each being spaced apart on the valve spool; wherein an all-metal-seal ring is assembled and fitted on each of the separation sleeves; and wherein each of the all-metal-seal rings is constructed with three different functioning ring layers: a cylinder seal layer, an absorption layer, and a shaft seal layer; wherein the cylinder seal layer seals the cylinder bore internal wall and does come into contact with the valve spool surface; wherein the absorption layer absorbs any dimensional variations during dynamic movement of the valve spool; and shaft seal layer seals the valve spool and does not come into contact with the cylinder bore internal wall.

### CLAIM FOR DOMESTIC PRIORITY

This application claims priority under 35 U.S.C. §119 to the United States Provisional Patent Application No. 61/508,046, filed Jul. 14, 2011, the disclosure of which is incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCES TO RELATED APPLICATIONS

This application is related to the Korea Patent Application No. 10-2006-0031762, filed Apr. 7, 2006, the disclosure of which is incorporated herein by reference in its entirety.

### FIELD OF THE INVENTION

The presently claimed invention relates generally to hydraulic systems and more specifically relates to the sealing of mechanical parts, including control valves, of hydraulic systems.

### BACKGROUND

Hydraulic actuators, including power cylinders, hydraulic motors, accumulators, and pumps are well known in the art. Typically, the actuation, or stop and go motion, of Hydraulic actuators is controlled by a sequence control system. There is a general desire in the art, along with the progress of the surrounding auxiliary technologies, to obtain faster and more accurate actuations under higher loads in hydraulic systems. Higher load, higher speed, and higher accuracy in the hydraulic systems are attainable only with higher internal pressure. A difficulty encountered with highly pressurized fluid is the sealing of mechanical parts, such as control vales, in a hydraulic system. One of the highest performance-demanded parts in a high-pressure control system is the spool type direction control valve.

Traditionally, a spool type direction control valve for high pressure hydraulic system does not have any sealing rings on the spool. The sealing of the spool relies only upon the precise dimensional fitting of the parts, which often approaches submicron level, and the fine finishing of the surface of the bore and surface of the spool for minimizing leaking There is no ideal sealing device for fitting in between the bore and the spool. Certain type of elastomeric materials such as polyamide can withstand 500 bar of pressure before it is extruded. However, elastomeric material cannot be used on the spool as sealing ring, and the reason is explained as below.

The construction spool type valve comprises at least two parts: the valve block and the spool. There must be minimum five ports on the valve block of spool type control valve: 1.) main power fluid supply port; 2.) output port A; 3.) output port B; 4.) return port of output port A; and 5.) return port of output port B. Five holes are drilled from the outer surface of the valve block into the cylinder and penetrate into the cylinder bore to connect the five ports from the outside with the cylindrical bore inside, allowing controlling fluid to flow through.

Drilling a hole that penetrates metal wall unavoidably creates burs on the opposite side of the metal wall, which are to be removed since the burs are always sharp and could damage contacting parts and cause the sticking of mating parts. Therefore, a subsequent processing is employed using, for example, chamfer tool to remove the burs. When the opposite side of the metal wall on which the hole is drilled is exposed, the burs can easily be chamfered eliminating sharp corner edge of the drilled hole. However, when the opposite side of the metal wall is the inside of a cylinder bore, the burs are not accessible to the chamfer process and the sharp corner edge of the drilled hole is left without chamfering. Furthermore, the hole inside the cylinder is not true circle but oval in shape as the drilled hole penetrates the cylindrical surface of the cylinder bore. The oval shape of the hole makes the corner edge even sharper when not chamfered.

Low pressure application spool valves such as those employed in pneumatic control systems with applicable pressure under 30 bar use elastomeric O-rings for spool sealing ring in the pneumatic spool valve since the rubber O-ring has adequate resiliency to overcome the un-chamfered sharp corner edges of the drilled holes inside of the cylinder bore of the spool valve when the internal pressure is very low.

On the other hand, it is impossible to have elastomeric sealing ring that have high enough strength to overcome 300 bar or higher internal pressure, which is the average pressure in current hydraulic systems, without being torn off at the sharp corner edges of the un-chamfered drilled holes inside of the high pressure hydraulic control spool valve. Therefore, spool type high-pressure hydraulic control valves are made without any sealing ring on the spool.

Since the sealing of the spool relies only upon the precise dimensional fitting of the parts and the fine finishing of the surface of the bore and surface of the spool, it necessitates costly and complicated manufacturing process. Using all-metal-seal rings on the spool of high-pressure hydraulic spool valve eliminate the aforementioned limitations as such metal sealing rings can withstand an applied pressure of multi-thousand bar.

### SUMMARY

It is an objective of the presently claimed invention to provide a design of a spool type hydraulic control valve that can withstand high internal pressure, has relatively low manufacturing complexity, relatively low requirement on precise dimensional fitting of the valve parts, and higher durability. It is a further objective of the presently claimed invention to provide such design with the use of all-metal-seal rings.

In accordance to various embodiments of the presently claimed invention, all-metal-seal rings are used for the sealing of the spool and the bore.

### BRIEF DESCRIPTION OF THE DRAWINGS

Embodiments of the invention are described in more detail hereinafter with reference to the drawings, in which:

FIG. 1a and FIG. 1b show the cross-sectional view of a spool type pneumatic valve that uses rubber O-rings for sealing, and illustrate the isolation and/or connection of the ports in each given control condition;

FIG. 2 shows the enlarged cross-sectional view of the valve body, spool, and rubber O-rings in an exemplary embodiment of a hydraulic system; and illustrates how the rubber O-ring could be torn out by the sharp corner edge of the un-chamfered drilled hole;

FIG. 3a and FIG. 3b show the cross-sectional view of a spool type pneumatic valve that uses all metal seal rings for sealing, and illustrate the isolation and/or connection of the ports in each given control condition; and

FIG. 4 shows the enlarged cross-sectional view of the valve body, spool, all-metal-seal rings in an exemplary embodiment of a hydraulic system in accordance to the presently claimed invention and illustrates how the all-metal-seal rings can withstand extremely high pressure without distortion or being damaged.

### DETAILED DESCRIPTION

In the following description, designs of hydraulic systems using all-metal-seal rings for sealing are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

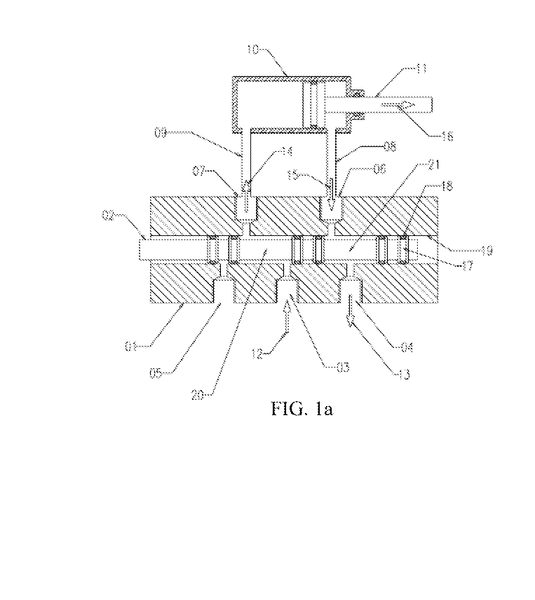

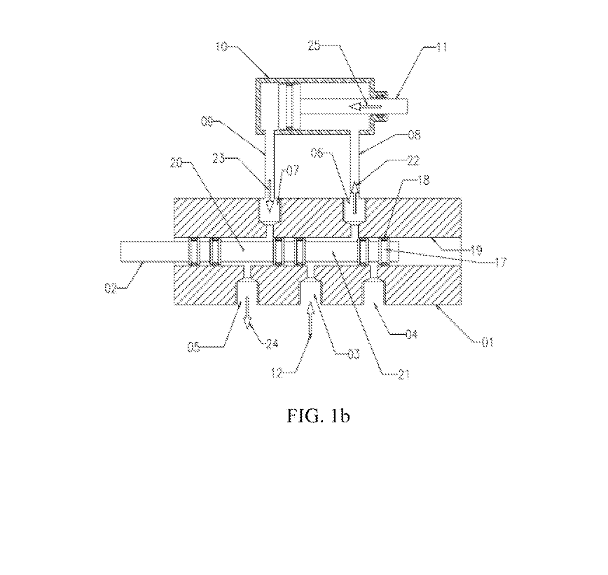

Referring to FIG. 1a, which shows the cross-sectional view of a spool type pneumatic valve that uses rubber O-rings for sealing with internal pressure not higher than 30 bar. FIG. la also illustrates the isolation and/or connection of the ports under the condition in which the piston is pushed out.

An elongated cylindrical hole 19 is made inside of a valve block 01 in which a valve spool 02 is inserted. The valve spool 02 has six grooves 17, and on each a rubber O-ring 18 is assembled or fitted upon. The rubber O-rings 18 operate to isolate or connect the valve ports 03-07 by sliding the valve spool 02 in or out of the cylindrical hole 19, hence shifting the positions of the rubber O-rings 18 in the cylindrical hole 19, as controlled by a logic controller (not shown in the drawing) of the pneumatic system.

Supplying compressed air or pressurized fluid in the flow direction 12 into a supply port 03 causes the compressed air or pressurized fluid to flow in the flow direction 14 through the spool neck 20, port 07, and tube 09 that is connected to an actuator cylinder 10. A piston 11 is then pushed outward in the direction 16 by the compressed air or pressurized fluid in the actuator cylinder 10. By the outward movement of the piston 11, the compressed air or pressurized fluid originally inside of the actuator cylinder 10 is pushed out in the flow direction 15 through tube 08 that is connected to port 06, through spool neck 21, and discharged out as in the flow direction 13 through the port 04.

Referring to FIG. 1b, which illustrates the isolation and/or connection of the ports under the condition in which the piston is pulled in. Supplying compressed air or pressurized fluid in the flow direction 12 into the supply port 03 causes the compressed air or pressurized fluid to flow in the flow direction 22 through spool neck 21, port 06, and tube 08 that is connected to the actuator cylinder 10. The compressed air or pressurized fluid pushes the piston 11 inward in the direction 25. By the inward movement of the piston 11, the compressed air or pressurized fluid originally inside of the actuator cylinder 10 is pushed out in the flow direction 23 through tube 09 that is connected to port 07, through spool neck 20, and discharged out in the flow direction 23 through the port 05.

As described in the abovementioned description, the piston 11 is moved to produce the actuation motion in either the outward direction 16 or the inward direction 25 by the sliding of the valve spool 02 position in and out of the valve block 01.

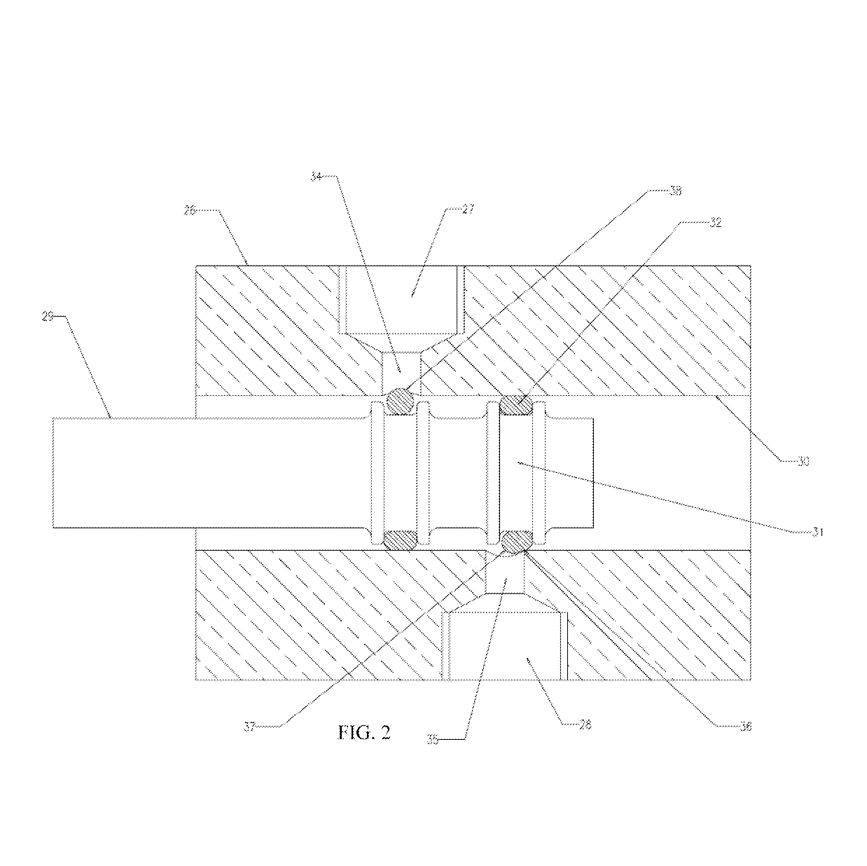

Referring to FIG. 2. Rubber O-rings are assembled and fitted on the grooves 31 of the valve spool 29. The rubber O-ring must be compressed to form an oval shaped cross section with a decreased outside diameter, as shown by the compressed the O-ring 32, in order to force insert into the valve bore 30. The valve bore 30 has a diameter smaller than the outside diameter of the uncompressed rubber O-ring, allowing the elastic expansion force of the rubber O-ring to maintain intimate contact with the valve bore 30 and the valve spool 29 simultaneously, thus creating the sealing effect.

In some instances with the rubber O-rings are shifted to the positions where the drilled holes are located, the rubber O-ring 38 returns to its original circle shaped cross section as shown by the O-ring 38 positioned at the drilled hole 34.

When the valve spool 29 slides again, shifting the rubber O-rings from their positions, the rubber O-rings can hit the sharp corner edge of the drill holes. This is illustrated by the O-ring 37 hitting the corner edge 36 of the drilled hole 35. The O-ring 37 is sheared by the sharp corner edge 36 and can be torn out, destroying the sealing function.

When the hydraulic system has a low internal pressure under 30 bar, the rubber O-rings can maintain their shape; but at an internal pressure of 300 bar or higher, the O-rings cannot maintain their shape and can be easily torn off, this is the reason why high pressure systems cannot use rubber O-ring. Consequently, sealing in high pressure system relies only upon the viscosity of the fluid used in the system, thus the clearance between the valve spool and valve bore wall must be kept as minimal as possible without causing the valve spool to be stuck.

The precision manufacturing process of the valve spool and valve bore involve boring, reaming, grinding, and honing. The alloy of the valve body is selected based on the requirement of low thermal expansion coefficient for avoiding dimensional changes due to temperature changes because of the precise clearance between the valve spool and valve bore wall. For the same reason, the valve body is to undergo extreme grade heat treatment to achieve low thermal deformation. The complex manufacturing process and quality control result in the associated high cost, and the treated alloy, having extra high strength and hardness from the treatments, makes the subsequent drilling and boring more difficult.

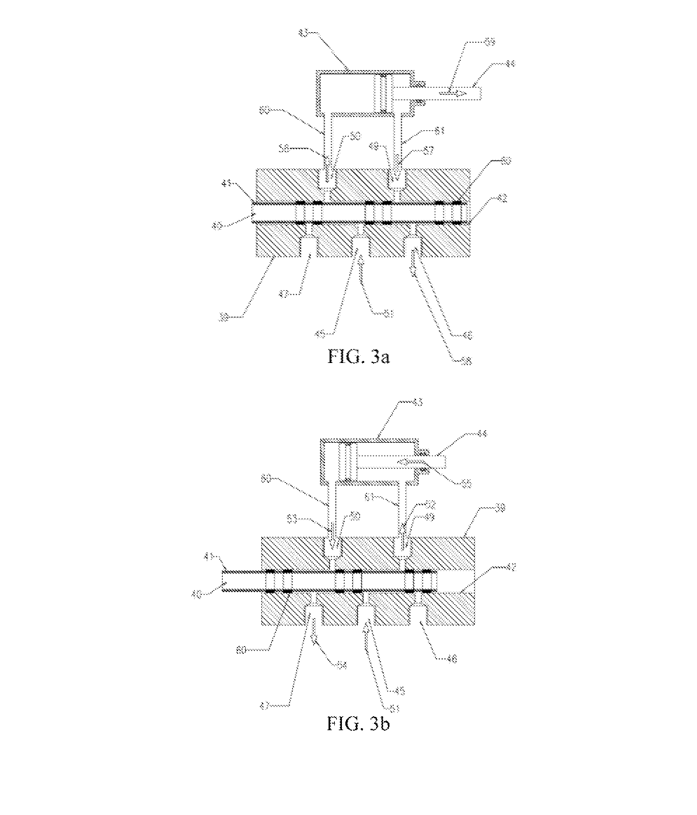

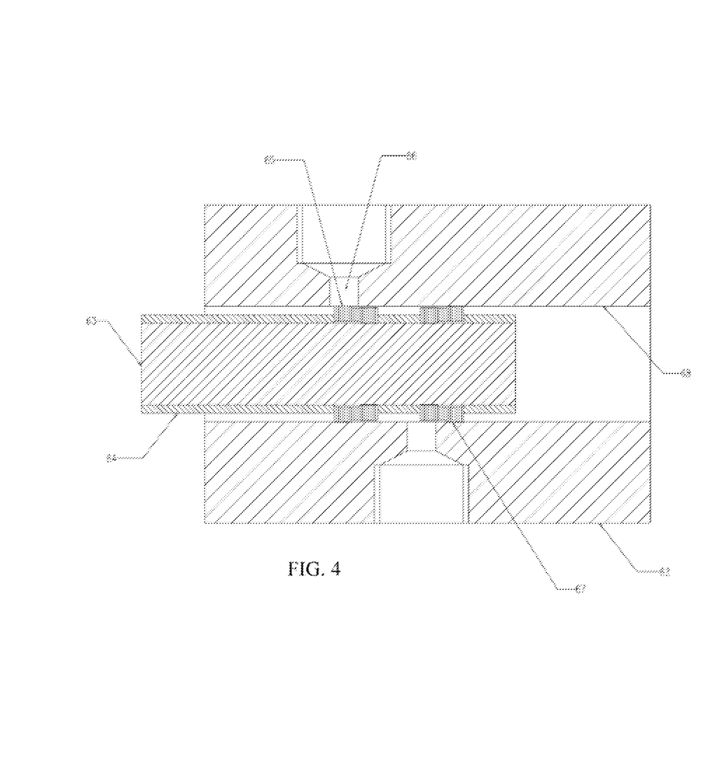

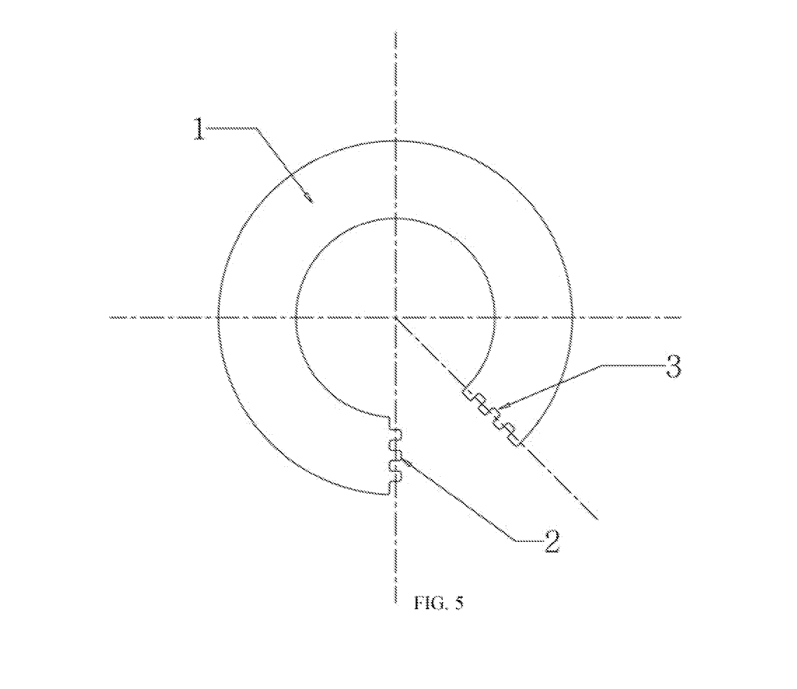

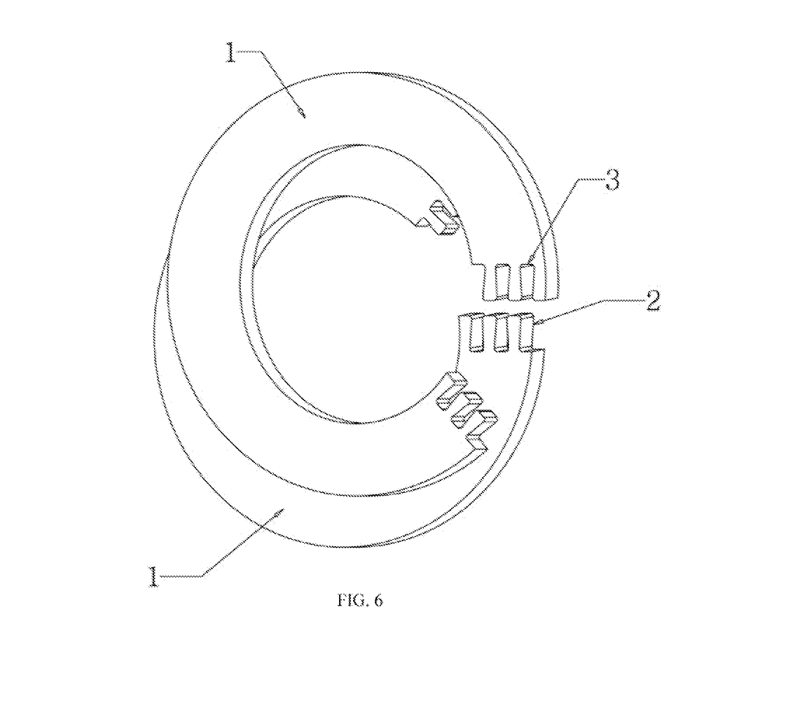

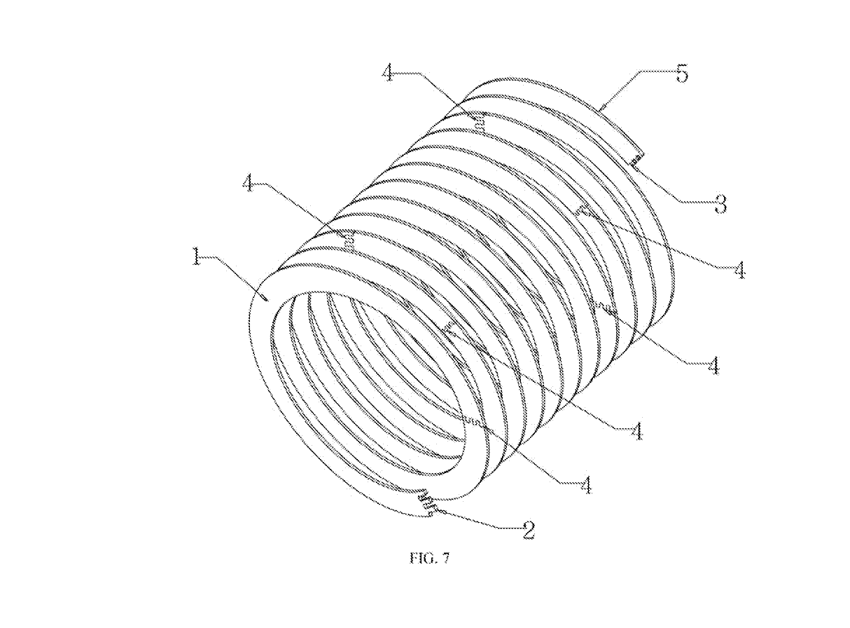

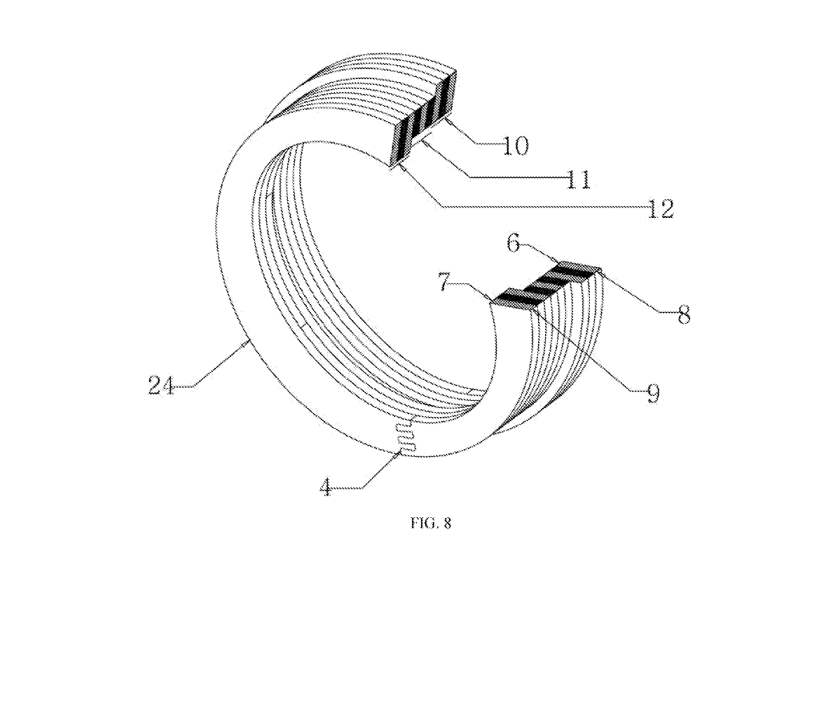

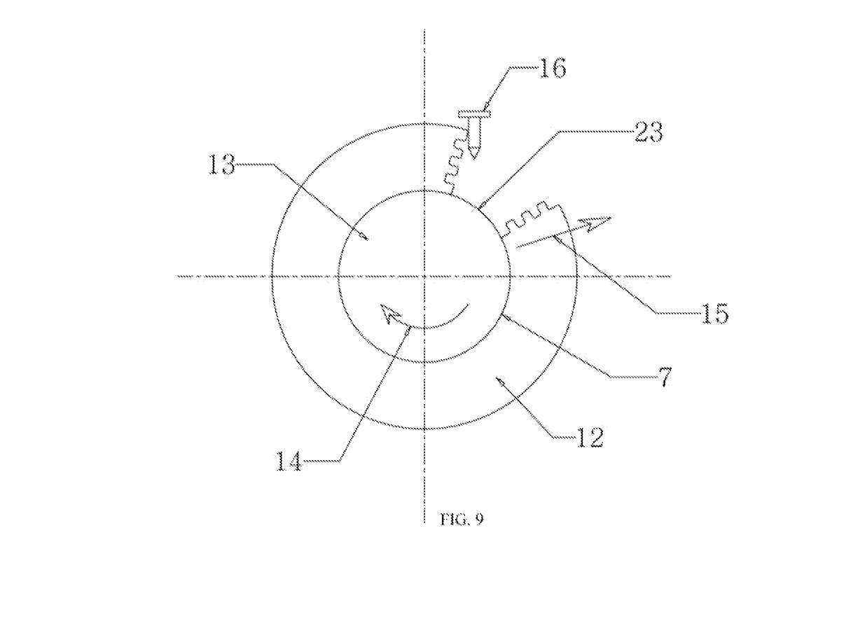

All-metal-seal rings in place of the rubber O-rings, on the other hand, are completely free from shearing off by the un-chamfered sharp corner edge of the drilled hole inside of the valve bore. Referring FIG. 3a and FIG. 3b. The figures show the cross-sectional view of a valve assembly fitted with all-metal-seal ring on the spool for high pressure application.

FIG. 3a illustrates the isolation and/or connection of the ports under the condition in which the piston is pushed out. An elongated cylindrical hole 42 is made inside of a valve block 39 in which a valve spool 40 is inserted. Six all-metal-seal rings 60 are mounted on the valve spool 40. The all-metal-seal rings 60 are kept on their respective predetermined locations on the valve spool 40 by the separation sleeves 41. Each of the all-metal-seal rings 60 is constructed with three different functioning ring layers: a cylinder seal layer, an absorption layer, and a shaft seal layer. The layers are constructed such that they form an inseparable single piece of all-metal-seal ring.

The cylinder seal layer seals the wall of the cylindrical hole 42 and does not come into contact with the surface of the valve spool 40. The absorption layer absorbs any dimensional variations during the dynamic movement of the valve spool 40. The shaft seal layer seals the valve spool 40 and does not come into contact with the wall of the cylindrical hole 42.

Supplying compressed air or pressurized fluid in the flow direction 51 into a supply port 45 causes the compressed air or pressurized fluid to flow in the flow direction 56 through the port 50 and tube 09 that is connected to an actuator cylinder 43. A piston 44 is then pushed outward in the direction 59 by the compressed air or pressurized fluid in the actuator cylinder 43. By the outward movement of the piston 44, the compressed air or pressurized fluid originally inside of the actuator cylinder 43 is pushed out in the flow direction 57 through tube 61 that is connected to port 49, and discharged out as in the flow direction 58 through the port 46.

Referring to FIG. 3b, which illustrates the isolation and/or connection of the ports under the condition in which the piston is pulled in. Supplying compressed air or pressurized fluid in the flow direction 51 into the supply port 45 causes the compressed air or pressurized fluid to flow in the flow direction 52 through port 49 and tube 61 that is connected to the actuator cylinder 43. The compressed air or pressurized fluid pushes the piston 44 inward in the direction 55. By the inward movement of the piston 44, the compressed air or pressurized fluid originally inside of the actuator cylinder 43 is pushed out in the flow direction 53 through tube 60 that is connected to port 50, and discharged out in the flow direction 54 through the port 47.

As described in the abovementioned description, the piston 44 is moved to produce the actuation motion in either the outward direction 59 or the inward direction 55 by the sliding of the valve spool 02 position in and out of the valve block 01.

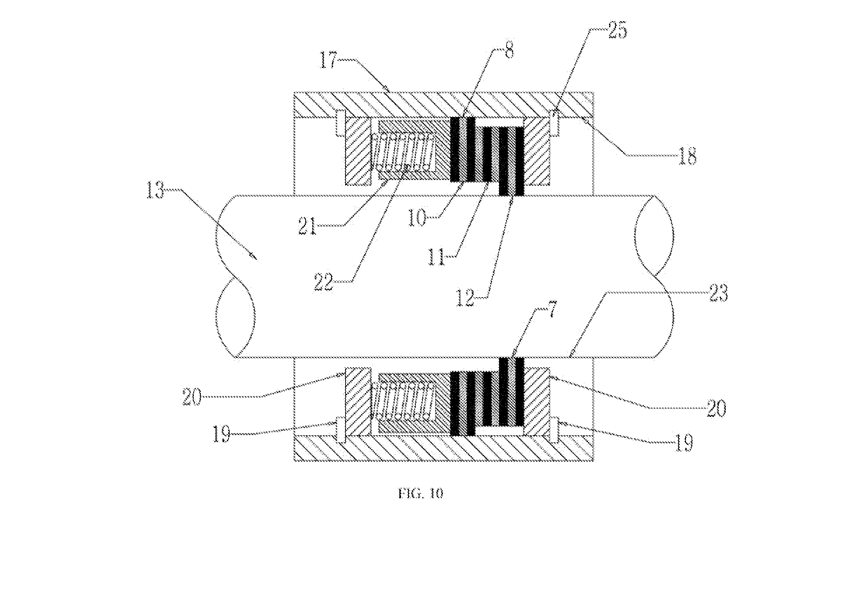

Referring to FIG. 4. All-metal-seal rings 65 and 67 are assembled and fitted on the separation sleeves 64 of the valve spool 63. In FIG. 4, the valve spool 63 is at a position such that the all-metal-seal ring 65 is situated at the location of the un-chamfered drilled hole 66.

The all-metal-seal rings have radial tension. As such the metal rings in an all-metal-seal ring can, by its radial tension, be expanded to have slightly bigger diameter and be contracted to have slightly smaller diameter. Each point on the ring circumference of the metal rings does not rise up or dimple down; unlike the rubber O-ring surface, which should be changed in shape as the contacting surface changes.

Therefore, even though the surface of the all-metal-seal rings 65 and 67 are situated at the locations of the un-chamfered drilled holes, they will not be torn or scratched by the meeting of any burs or sharp corner edge of the un-chamfered drilled holes. The sealing function remains effective. The durability of the valve fitted with all-metal-seal rings, thus, increases dramatically.

One embodiment of the all-metal-seal ring is the coiled felt seal (CFS). One exemplary embodiment of CFS is the helical spring tube type dynamic rotary seal. It is described in the Korea Patent Application No. 10-2006-0031762. Excerpts of its English translation are presented in the Appendix A of the present document.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

### APPENDIX A

Helical spring tube type dynamic rotary seal constructed with C-type partial rings, which are joined by dovetail joint method

### Brief Description of Drawings

FIG. 5: Partial ring which could be press stamped out of thin metal sheet, that having male and female dovetail joint shape on two ends to make the joints be strong when progressively joined.

FIG. 6: Two partial rings are overlapped to insert male dovetail of first partial ring into female dovetail of next partial ring for progressive joining to construct helical wound tube.

FIG. 7: Blank of the tubular shape seal of this invention, which is metal strap wound helical tube.

FIG. 8: Partially cutaway view of completed dynamic seal of this invention which is completed by grinding the inside and outside diameter of the blank to have proper function in the seal.

FIG. 9: A partial ring with assisting imaginary parts to explain the dynamic rotary seal principle with this invention.

FIG. 10: Half cutaway view of example of completed dynamic rotary seal using this invention.

### Explanation of Numbered Parts in the Drawings FIGS. 5-10

1—A partial ring stamped out of thin metal sheet.

2—Male end of dovetail joint on C-type partial ring.

3—Female end of dovetail joint on C-type partial ring.

4—Dovetail Joint line, which is the result of dovetail joining of C-type partial rings.

5—Helical spring tube constructed by progressive joining of number of C-type partial rings along the helical track.

6—Shaft free circle that made slightly bigger diameter than the shaft diameter to keep it away from shaft all the time.

7—Shaft contact circle that made slightly smaller than shaft diameter to make it keep contact with shaft all the time.

8—Housing contact circle that made slightly bigger than inside diameter of the housing to make it keep contact with housing all the time.

9—Housing free circle that made slightly smaller than inside diameter of the housing to keep it away from the housing all the time.

10—Hosing seal layer whose outside diameter is housing contact circle and inside diameter is shaft free circle.

11—Displacement absorption layer whose outside diameter is housing free circle and inside diameter is shaft free circle.

12—Shaft seal layer whose outside diameter is housing free circle and inside diameter is shaft contact circle.

13—Shaft.

14—Arrow to indicate the shaft rotating direction.

15—Arrow to indicate the spreading direction of shaft seal ring when the ring spreads.

16—An imaginary pin which blocks rotating of shaft seal ring.

17—Housing.

18—Inside diameter of the housing.

19—Snap ring that inserted in snap ring groove to the hold holding ring.

20—Holding ring that holds the seal ring assembly.

21—Compression ring that pushes source rings of seal ring assembly to keep all the rings in seal ring assembly be tightly contacted one another to block leak between rings.

22—Compression spring to provide compression force of compression ring.

23—Outside diameter of the rotating shaft.

24—Completed seal assembly.

25—Snap ring groove.

### Detailed Description

Category of this invention falls in the dynamic blocking technology of the leak that inevitably arising between stationary housing and rotating shaft when pressure rises in the rotary compression system.

The dynamic rotary seal used on screw type compression system is called “mechanical seal”. A mechanical seal is composed of six parts in minimum, which are the stator block, rotor block, stator disk, rotor disk, rotor disk spring and rotor block disk seal. The entire seal function fails if any one of these parts fails. The stator disk and the rotor disk are the parts that perform the actual sealing function by contacting rubbing rotating under pressure. Those two parts must have not only high wear resistance but also low friction. They must be able to dissipate heat in possible highest speed.

Surface area can be adjusted for less contacting area for less friction heat but the less area results faster wear out. High wear resistant materials have high friction but low friction material having low wear resistance. If they are made with high wear resistant material for long life the friction heat could affect the quality of the media in contact, in some cases even bring fire.

Two contacting faces in mechanical seal are under pressure and constantly rubbing so they are wearing in all instance even submicron unit range but that submicron wear clearance always causes whole seal failure when the submicron wear is not compensated in every instance along with wear out.

In other words, one of the contacting disk, rotating disk, must move toward the mating disk, the stationary disk, to compensate wear. This means the rotating disk must travel axial direction toward the stationary disk on the rotating block while the rotating block is rotating. Rotating disk must be able to slide on the rotating block to constantly move toward the stationary disk. Thus there is another place to block leak between rotating disk and rotating block.

The axial direction movement of the rotating disk on the rotating block by wear out of disk is very little distance, within few mm in a year, so the sealing between rotating disk and rotating block could be satisfied by simple rubber O-ring for cheaper model and by metal bellows for higher performance. In short the real problem in rotary dynamic seal in prior art is in the sealing between rotating disk and rotor block, not only in contacting disks.

A rubber O-ring inserted between rotating disk and rotor block shall be burnt in high temperature media and shall be extruded under high pressure media and be attacked in the corrosive media but there are no ways to omit it.

Metal bellows are more expensive, sometimes three times of the whole mechanical seal, and the metal bellows makes complicate structure which hinders thin compact design that is very important in precision machines.

The ultimate target is to produce single piece rotary dynamic seal which is compact, higher sealing performance, cheaper and lower maintenance while the rotary dynamic sealing system of prior art which generally called mechanical seal having so many parts are inevitably inter related, complicate structure, expensive in production cost, higher maintenance cost and shorter life.

FIG. 5 shows the C-shaped partial ring (1) which is the basic source ring of this invention. Partial ring (1) must be stamped out by press or fabricated by contour cutting process such as laser cutting or wire cutting from sheet stock to have two faces of partial ring (1) in perfect parallel. C-shaped partial ring (1) is a ring that made to have a part of the ring cut away so as to make the partial rings be progressively joined by the male dovetail (2) and female dovetail (3) made on two ends of the partial ring (1). The value of the cut away angle should be determined accordingly along with diameter.

FIG. 6 shows the method of progressive joining of two partial rings (1) by the male dovetail (2) of first partial ring (1) and female dovetail (3) of next partial ring (1).

FIG. 7 shows the completed helical spring tube (5) by progressive joining of partial rings (1) and those dovetail joint line (4) must be permanently set by welding or brazing after joining The starting point shows the male dovetail (2) and the ending point shows female dovetail (3) on completed helical spring tube (5). As the helical spring tube (5) is constructed by the progressive joining of the partial rings (1) the dovetail joint line (4) shall be distributed on the tube surface on shifted point as much as the cutaway angle of the partial ring (1) so the dovetail joint line (4) will be adequately distributed on tube surface evading weak joint points be overlapped.

FIG. 8 shows the partial cutaway view of seal assembly (24) which is completed sealing ring of this invention. The seal assembly (24) is completed by grinding of inner diameter and outer diameter by making 4 different diameters, two on inside and two on outside of the helical spring tube (5). The smaller diameter of the inside diameter of seal assembly (24) is called shaft contacting circle (7) which is made about 0.5% smaller than the outside diameter of the shaft (23) so as to tightly contact with shaft (13) all the time when the shaft (13) is inserted inside of the seal assembly (24). The larger diameter of the inside diameter of seal assembly (24) is called shaft free circle (6) which made little larger than the outside diameter of the shaft (23) so as to prevent shaft free circle (6) from contacting outside diameter of the shaft (23) at anytime. The larger diameter of the outside diameter of seal assembly (24) is called housing contact circle (8) which is made about 0.5% larger than the inside diameter of the housing (18) so as to keep the housing contact circle (8) tightly contact all the time with inside diameter of the housing (18) when the seal assembly (24) is assembled inside of the housing (17). The smaller diameter of the outside diameter of the seal assembly (24) is called housing free circle (9) which made little smaller than the inside diameter of the housing (18) to prevent the housing free circle (9) from contacting the inside diameter of the housing (18) at anytime. The purpose of making these 4 different diameter circle is to build three different functioned layers in the seal assembly (24). The first layer is called housing seal layer (10), which is the stacking of the housing seal rings whose outside diameter is housing contact circle (8) and inside diameter is shaft free circle (6). The function of the housing seal layer is blocking the leak between inside diameter of the housing (18) and seal assembly (24) and the number of the rings to construct layer for optimum sealing performance shall be determined by designer according to different sizes. The second layer is called shaft seal layer (12) which is the stacking of the shaft seal rings whose outside diameter is housing free circle (9) and inside diameter is shaft contact circle (7). The function of the shaft seal layer is blocking the leak between outside diameter of the shaft (23) and seal assembly (24) and the number of the rings to construct layer for optimum sealing performance shall be determined by designer according to different sizes. The third layer is called displacement absorption layer (11) which is stacking of the suspended rings whose outside diameter is housing free circle (9) and the inside diameter is shaft free circle (6). The displacement absorption layer (11) is built between the housing seal layer (10) and the shaft seal layer (12) to absorb eccentric vibration of the shaft and also absorbs the dimensional change of the whole system by wearing along with use.

FIG. 9 shows the principle of the sealing of this invention. Since those three different functioned layers are constructed on a single strand of metal strap any force put to any point of the seal assembly (24) is immediately affects to all over the seal assembly (24). When the seal assembly (24) is inserted inside of the housing (17) with force the seal assembly (24) is tightly caught inside of the housing (17) because the outmost diameter of the seal assembly (24) is the housing contact circle (8) which is 0.5% larger than the inside diameter of the housing (18). As the housing seal layer (10) is tightly caught to the housing (17) whole seal assembly (24) is caught in the housing (17) so is the shaft seal layer (12). The innermost diameter of the seal assembly (24) which is the inner diameter of the shaft seal layer (12) is shaft contact circle (7) which is made about 0.5% smaller than the outside diameter of the shaft (23) so if the shaft (13) is inserted into shaft seal layer (12) by force whole shaft seal layer (13) must be tightly stick to shaft (13). If the shaft (13) starts rotate the shaft seal layer (12) also starts to rotate together with shaft (13) but the housing seal layer (10) which is tightly caught inside of the housing (17) prevents the shaft seal layer (12) from rotating.

This condition is as same as the FIG. 9 that shows one partial ring of the shaft seal layer (12) is about to start rotate by the rotating force of the shaft (13), the stopping action of the housing seal layer (10) is shown by imaginary stop pin (16). The shaft contact circle (7) is holding shaft diameter (23) but the shaft (13) starts to rotate to arrow (14) direction while the stop pin (16) prevents the ring (12) from rotate, then the friction force between shaft contact circle (7) and shaft diameter (23) is converted to open the partial ring (12) to the arrow (15) direction. When the partial ring (12) opens by the force arrow (15) direction the contacts between the ring (12) and shaft (13) is broken, other words there remain no more contact in that instance. No more contact means no more friction force generates so opening of the ring (12) is ended and spring back to its original position. Back to its original position of the ring (12) means the contacting of the ring (12) and shaft (13) and next instance the friction force opens the ring (12) again. The opening between the ring (12) and the shaft (13) could be a millionths of a mm since the open is open no matter how small value was the opening which is enough distance to eliminate contacting. So the open and close of the ring (12) could arise million times in a second in other words the opening clearance also could be millionths of a mm through which nothing can be leak in a millionths of a second. This condition is as same as the static seal of plain rubber O-ring since the contacting of ring (12) and shaft (13) is virtually never broken during the rotating of the shaft (13). This status is a unique phenomenon arising between helical spring and rotating round bar inserted inside of the spring, the condition should be called contacting non contacting condition. This contacting non-contacting phenomenon is utilized on helical spring over running clutch from long time ago but utilizing this phenomenon on dynamic seal is the first on this invention.

FIG. 10 is the representative drawing which shows the cutout view of completed dynamic rotary seal using seal assembly (24). There must be some means to hold the seal assembly (24) inside the cylinder (17) including holding ring (20) and snap ring (19) which is inserted in the snap ring groove (25). The compression ring (21) also provided to push source rings together to block leak between source rings by the spring force of the compression springs (22) which inserted in the holes made on the compression ring (21).

What is claimed is:

1. A spool type control valve, comprising:
a valve block having a cylinder bore with one or more drilled holes on the cylinder bore internal wall;
one or more ports being on the valve block, each connecting outside of the valve block to each of the drilled holes;
a valve spool being inserted in the cylinder bore;
wherein the valve spool having one or more separation sleeves each being spaced apart on the valve spool;
wherein each of one or more all-metal-seal rings being assembled and fitted on each of the separation sleeves; and
wherein the all-metal-seal rings creating one or more sealed chambers between the valve spool and the cylinder bore for isolations and connections of the ports when the valve spool slides in and out of the cylinder bore changing the positions of the all-metal-seal rings in relative the drilled holes.

2. The spool type control valve of claim 1, wherein each of the all-metal-seal rings being constructed with three different functioning ring layers: a cylinder seal layer, an absorption layer, and a shaft seal layer;
wherein the cylinder seal layer seals the cylinder bore internal wall and does come into contact with the valve spool surface;
wherein the absorption layer absorbs any dimensional variations during dynamic movement of the valve spool; and
shaft seal layer seals the valve spool and does not come into contact with the cylinder bore internal wall.

3. The spool type control valve of claim 1, wherein the all-metal-seal rings being coiled felt seals.
